(19) United States
(12) Patent Application Publication
(10) Pub. No.: US 2024/0375429 A1
(43) Pub. Date: Nov. 14, 2024

(54) CONFIGURABLE WHEEL

(71) Applicant: Re:Build Manufacturing, LLC, Framingham, MA (US)

(72) Inventors: Jack Wilfley, Framingham, MA (US); Richard Seale, Leamington Spa (GB); Fraser Dunn, Aston Cantlow (GB); Marcello Grassi, Guildford (GB)

(21) Appl. No.: 18/655,805

(22) Filed: May 6, 2024

Related U.S. Application Data
(60) Provisional application No. 63/465,191, filed on May 9, 2023.

(51) Int. Cl. B60B 21/02; B60B 21/12

(52) U.S. Cl. CPC B60B 21/02; B60B 21/12

(57) ABSTRACT

A configurable wheel is provided with: a wheel drum, the wheel drum having a first rim of a first diameter on a first end of the wheel drum; a second rim of the first diameter on a second end, opposite to the first end, of the wheel drum; a facing that extends between a second diameter and a third diameter positioned concentrically to the first rim on the first end in a plane substantially perpendicular to an axis of rotation of the wheel drum; and a cavity defined inward from the second rim from the second end toward the first end; and a halo, connected to the wheel drum in an interstitial band defined on the first end between the first diameter and the second diameter.

### CROSS-REFERENCE TO RELATED APPLICATIONS

The present disclosure claims the benefit of U.S. Provisional Patent Application No. 63/465,191 entitled “CONFIGURABLE WHEEL”, and filed on May 9, 2023, which is incorporated herein by reference in its entirety.

### BACKGROUND

Vehicle manufacturers are increasingly using carbon fiber and plastic components to reduce the mass of their vehicles, but have generally avoided using these materials in the design of wheels for those vehicles. Although non-metallic materials can offer significant weight savings compared to most metal alloys, the cost and susceptibility to damage of these materials relative to alloys makes these materials impractical for use in wheels for most vehicles. Even high performance vehicles, which currently use carbon-fiber wheels, must often replace chipped or cracked components and these vehicles rely on specifically engineered wheel components to interact with the other elements of the vehicle (e.g., axles, brakes, sensors, wheel-wells, etc.) making replacement of the wheel both frequent and difficult.

### SUMMARY

The present disclosure is generally related to a configurable thermoplastic wheel design. The present disclosure provides devices, systems, and methods that provide a configurable wheel with improved durability, airflow properties, and design modularity, among other benefits.

One embodiment of the present disclosure includes a wheel, comprising: a wheel drum, the wheel drum having a first rim of a first diameter on a first end of the wheel drum; a second rim of the first diameter on a second end, opposite to the first end, of the wheel drum; a facing that extends between a second diameter and a third diameter positioned concentrically to the first rim on the first end in a plane substantially perpendicular to an axis of rotation of the wheel drum; and a cavity defined inward from the second rim from the second end toward the first end; and a halo, connected to the wheel drum in an interstitial band defined on the first end between the first diameter and the second diameter.

One embodiment of the present disclosure includes a system, comprising: a wheel drum, having: a first rim of a first diameter on a first end; a second rim of the first diameter on a second end opposite to the first end; and a sidewall connected to the first rim and the second rim, having a second diameter less than the first diameter; wherein the first end defines: an interstitial band, extending inward from the first rim toward the second end, the interstitial band positioned circumferentially between the first diameter and a third diameter, less than the first diameter; a facing, positioned extending substantially perpendicular to an axis of rotation of the wheel drum, the facing positioned circumferentially between the third diameter and a fourth diameter, less than the third diameter; and a well, extending inward from the facing toward the second end, the well positioned circumferentially within the fourth diameter; wherein the second end defines: a cavity, extending inward from the second rim towards the first end; a first halo, having: a first engagement device, configured to selectively attach to the first end of the wheel drum within the interstitial band; and a first intake face, defining a first plurality of ducts defined circumferentially around the first halo; a second halo, having: a second engagement device, configured to selectively attach to the first end of the wheel drum; and a second intake face, defining a second plurality of ducts defined circumferentially around the second halo, wherein the second plurality of ducts differs in design from the first plurality of ducts.

One embodiment of the present disclosure includes a method, comprising: inserting a first halo including a first plurality of ducts in an interstitial band of a wheel drum to between a first rim and a facing of the wheel drum, the first rim having a first diameter and the facing occupying a region substantially perpendicular to an axis of rotation of the wheel drum between a second diameter and a third diameter, wherein the second diameter is less than the first diameter and the third diameter is less than the second diameter; securing the first halo to the wheel drum; releasing the first halo from the wheel drum; removing the first halo from the interstitial band; inserting a second halo in the interstitial band, the second halo including a second plurality of ducts different in design from the first plurality of ducts; and securing the second halo to the wheel drum.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a corresponding second Figure without disclaiming the inclusion of those elements in the embodiments illustrated or discussed in relation to the second Figure.

FIGS. 1A-1C illustrate example designs for a wheel installed on a vehicle, according to embodiments of the present disclosure.

FIGS. 2A and 2B illustrate a cross-sectional views of an example wheel, according to embodiments of the present disclosure.

FIGS. 3A-3B illustrate isometric views of example drums, according to embodiments of the present disclosure.

FIGS. 4A-4D illustrate example halos in various views, according to embodiments of the present disclosure.

FIGS. 5A-5C illustrate isometric views of example caps, according to embodiments of the present disclosure.

FIGS. 6A-6C illustrate views of an example puck, according to embodiments of the present disclosure.

FIGS. 7A-7D illustrate exploded views of a wheel, according to embodiments of the present disclosure.

FIG. 8 illustrates a protective use scenario of an example wheel, according to embodiments of the present disclosure.

FIGS. 9A-9B illustrate differences in airflows in different example wheel designs, according to embodiments of the present disclosure.

FIG. 10 is a flowchart of an example method for wheel configuration or repair, according to embodiments of the present disclosure.

### DETAILED DESCRIPTION

The present disclosure is generally related to a configurable thermoplastic wheel design. The present disclosure provides devices, systems, and methods that provide a configurable thermoplastic wheel with improved durability, airflow properties, and design modularity, among other benefits.

The described wheel is made of a continuous fiber reinforced thermoplastic, which offers substantial weight reduction compared to typical aluminum or steel wheels, and is designed to improve vehicle range and ride quality. Although composite materials have been used to make high performance automotive wheels, these wheels are designed using continuous fiber reinforced thermoset composite materials with the typical ‘barrel-hub-spoke’ configuration, using an integrated spoke/mag wheel face that is either molded into the hub and drum (also referred to as a barrel), or fastened to the hub and drum with hardware.

The described wheel can use a continuous fiber reinforced thermoplastic composite drum as the primary structure of the wheel, and connect various elements to the drum to provide additional structure. By using a thermoplastic composite for the drum (the largest component of the wheel), significant weight savings can be achieved in the wheel, which can lead to improved fuel or battery efficiency, but these lighter materials are more susceptible to damage than traditional alloy materials used in drums. Accordingly, the design of the drum includes various features to improve the resiliency of the drum against damage and to provide improved aerodynamics, and for the inclusions of one or more of a halo and a cap at different portions of the drum to protect the underlying drum and provide (in the event of damage) for easier repair or replacement than the drum or the wheel as a whole.

The drum may be used together with an outer halo or “aero ring” that forms the radial portion of the wheel face, and can be configured for each vehicle and brake type to tailor the aerodynamic and brake cooling properties of the wheel to a particular vehicle or use case for the vehicle. The halo and a centrally positioned cap, can be made of a thermoplastic or another material, and provides a protective layer around the outward facing elements of the drum; reducing the risk of damage to the lightweight drum, and providing for adjustments to the aerodynamics, air intake/outtake properties, and aesthetics of the wheel. Accordingly, the prior designs lack a selectively replaceable outer wheel face that provides the various benefits of the wheel described herein.

The described wheel includes various individual thermoplastic components, joined together to create a single, structural, lightweight wheel. The wheel uses thermoplastic composite materials, which are capable of being produced in high rates with significant automation, and are lower cost than traditional thermoset composite materials. The wheel uses an outer halo that comprises the outer portion of the wheel face surface, which includes an inner aerodynamic ‘flat’ profile. Together, these components can be designed to meet the unique aerodynamic and brake cooling requirements for specific vehicle types.

In addition to customizing the halo for aerodynamic and cooling purposes, the halo and the cosmetic surface panel inside of the halo can be changed to alter the aesthetics of the wheel based on personal design preferences. The halo can be easily replaced, which keeps the wheel looking new and ‘fresh’ (e.g., after curb impact, debris strike, etc.), and protects the inner drum from damage.

Additionally, the presently described wheels offer benefits in reducing vibration and sound produced by the wheels, which may be particularly important in electric vehicles (or hybrid vehicles operating in electric mode) due to the lack of engine noise compared to vehicles using internal combustion engines.

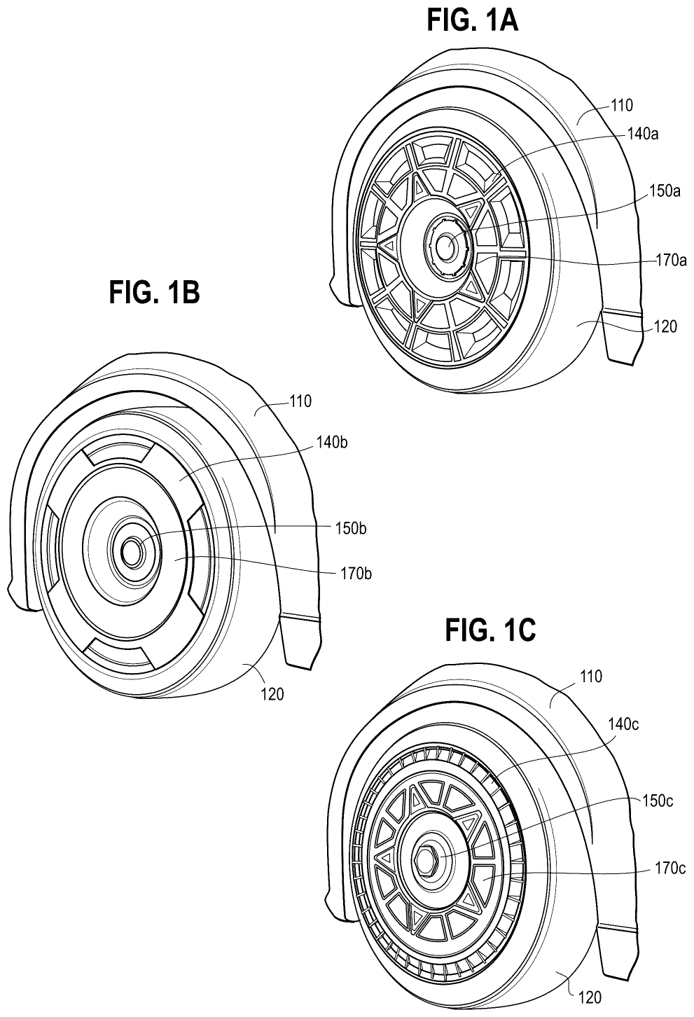

FIGS. 1A-1C illustrate example designs for a wheel 100, according to embodiments of the present disclosure. In each of FIGS. 1A-1C, a wheel 100 is shown on the same vehicle 110 with the same tire 120, but with different designs for exterior components of a halo 140a-c (generally or collectively, halo 140), a facing of the drum 130a-c (generally or collectively, drum 130), and a cap 150a-c (generally or collectively, cap 150). Although at least partially obscured in FIGS. 1A-1C, the interior components of the wheel 100 include a wheel drum 130 to which the tire 120 is affixed, and a supporting puck 160 to strengthen a connection with an axle of the vehicle 110 that is affixed to the wheel 100.

In various embodiments, the exterior components (e.g., the halo 140, the facing 170, and the cap 150) are configured to selectively engage as members of the wheel 100, such that a user may freely remove and reattach one or more of the exterior components as part of regular maintenance or to generally replace the parts without causing damage thereto.

For example, a user may use the same tire 120 and wheel drum 130 with the same vehicle 110, but replace the first halo 140a and the first cap 150a with the second halo 140b and the second cap 150b to reconfigure the wheel 100 from the example shown in FIG. 1A to the example of the wheel 100 in FIG. 1B if the same wheel drum 130 is used. Similarly, the user may replace the first halo 140a and the first cap 150a with the third halo 140c and the third cap 150c to reconfigure the wheel 100 from the example shown in FIG. 1A to the example of the wheel 100 in FIG. 1C, while still using the same tire 120 and wheel drum 130 with the same vehicle 110. The user may also revert these changes-reattaching the first halo 140a and the first cap 150a to the wheel drum 130 to revert from the example shown in FIG. 1B or FIG. 1C to the example shown in FIG. 1A. Although not illustrated, a user may also mix and match the components in any of FIGS. 1A-1C (or other instances of the components than those illustrated) to customize the look and performance of a wheel 100, and such customization is understood to be within the scope of the present disclosure.

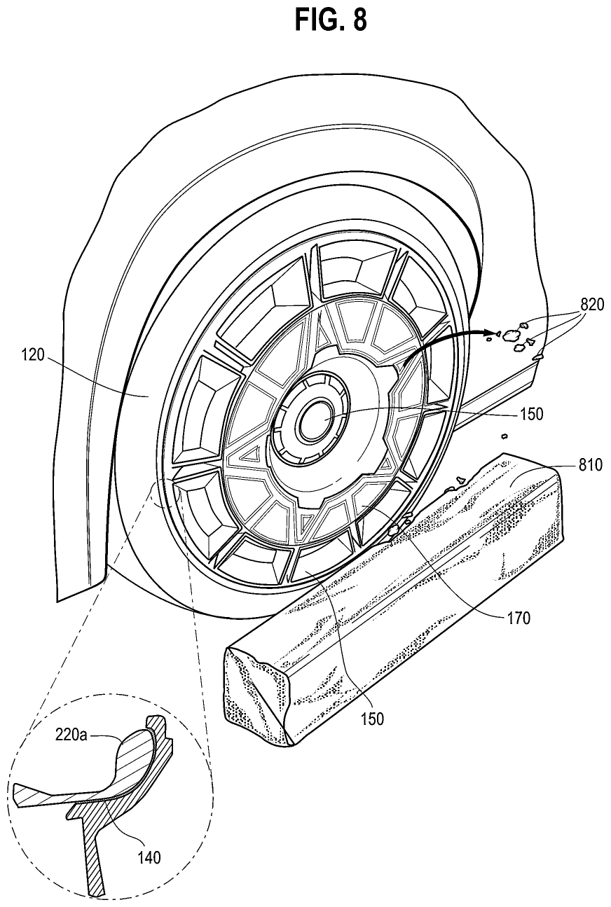

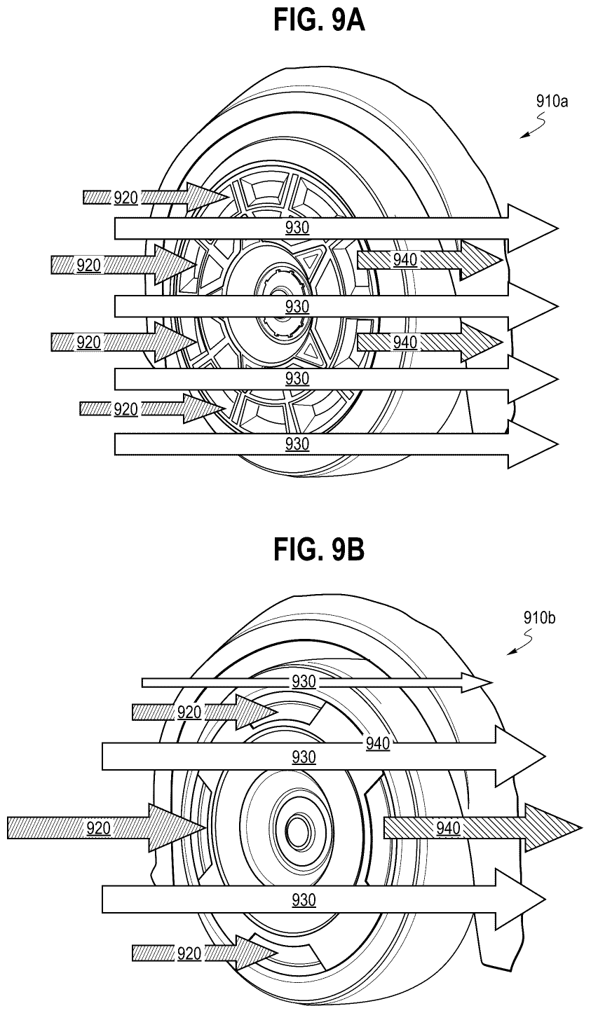

In various embodiments, the user may replace the exterior components for aesthetic reasons, to repair damage to the protective exterior components (as discussed in greater detail in regard to FIG. 8), to change airflow characteristics of the wheel 100 (as discussed in greater detail in regard to FIGS. 9A-9B), and combinations thereof.

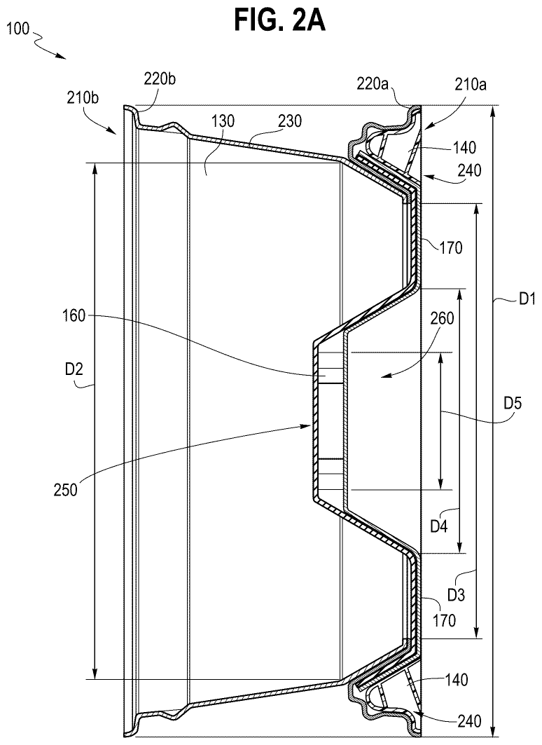

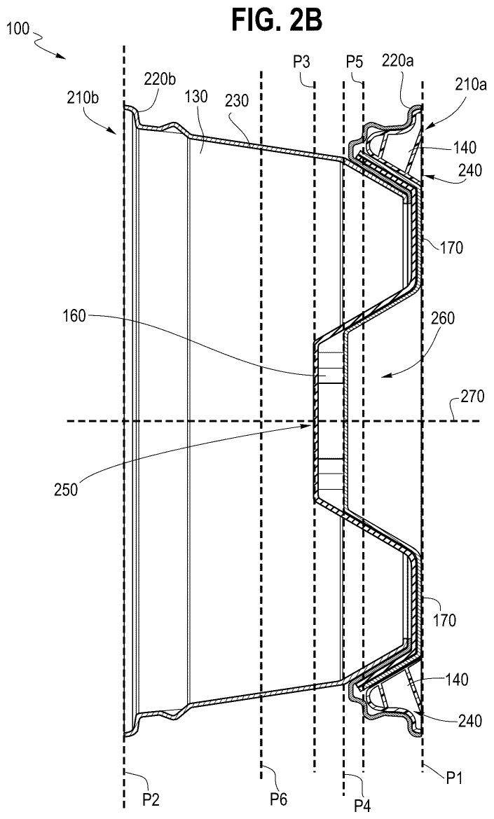

FIGS. 2A and 2B illustrate cross-sectional views of an example wheel 100, according to embodiments of the present disclosure, with FIG. 2A identifying different diameters of interest and FIG. 2B identifying different planes of interest. The wheel 100 includes a wheel drum 130, having a first diameter D1 at a first rim 220a (generally or collectively, rim 220) on a first end 210a (generally or collectively, end 210) of the wheel 100 and at the second rim 220b on the second end 210b of the wheel 100, opposite to the first end 210a. The rims 220 provide attachment points and mating surfaces to which the beads of a tire 120 may be secured when assembling the wheel 100 to affix the tire 120 to the wheel drum 130. The rims 220 include various flanges and mounting humps to hold the tire onto the edges of the wheel drum 130 and ensure that rotational energy is transferred from the wheel drum 130 to the tire 120 when driving.

Between the first rim 220a and the second rim 220b, the wheel drum 130 includes a sidewall 230, on which an inner tube of a tire 120 may rest or with which the inner liner of a tubeless tire forms a pressurized region when the wheel 100 is fully assembled. In various embodiments, the sidewall 230 may have a variable diameter that decreases between the first end 210a and the second end 210b, with a diameter decreasing to a second diameter D2 before returning to the first diameter D1 at each end 210 (e.g., via mounting slopes).

In various embodiments, the drum 130 is made of a thermoplastic composite that is reinforced with various materials. The drum 130 may be formed via injection molding, vacuum forming, additive material deposition, In various embodiments, the thermoplastic material may include an acrylic, acrylonitrile butadiene styrene (ABS), nylon (e.g., PA6, PA66, PA12, and other variants), polylactic acids (PLA), polybenzimidazole (PBI), a polycarbonate, a polysulfone, polyoxymethylene (POM), a polyaryletherketone (PAEK), polyetherimide (PEI), a polyethylene (PE), polyphenylene oxide (PPO), polyphenylene sulfide (PPS), polypropylene (PP), polyvinyl chloride (PVC), [olyvinylidene fluoride (PVDF), or polytetrafluoroethylene (PTFE) as a base resin. Various reinforcing materials may be incorporated into the base resin to add strength thereto, which may include carbon or organic-based filaments, fibers, sheets, meshes, and nanotubes; fiberglass filaments, fibers, sheets, meshes, and nanotube; metal filaments, fibers, sheets, meshes, and nanotubes; and combinations thereof. The present disclosure contemplates that other materials may be used in a composite wheel having components as described herein, and the recited materials are provided as non-limiting examples from which to make at least one component of such a wheel.

Similarly to the drum 130, the halos 140 and cap 150 may be made of a thermoplastic composite, but may be made of different materials (or a different construction of the same materials) than the drum 130 to provide greater resistance to impact than the material of the drum 130. For example, the halo 140 and the cap 150 may be made of a metal (e.g., aluminum, steel, titanium, bronze, brass), a renewable organic (e.g., wood, bamboo, paper products), and may use a different combination or ratio of base resin and reinforcement materials than the drum 130. Additionally or alternatively, the halos 140 and caps 150 may include various surface treatments to provide outer surfaces with different impact properties or aesthetic properties than the core materials used therein.

The first end 210a of the drum 130 includes the facing 170, which is oriented substantially perpendicular to an axis of rotation for the wheel 100. The facing 170 occupies an area between a third diameter D3 and a fourth diameter D4 (both less than the first diameter D1) in which a well 260 is defined. In various embodiments, the facing 170 may be made from a different material than the drum 130, include a coating that is applied to the first end 210a of the drum 130, or be a sheet of another material secured to the first end 210a of the drum 130 (e.g., via one or both of the halo 140 and the cap 150), which can include various aesthetic designs, provide color options, or provide greater resistance against debris strikes than what is offered by the material used in the rest of the drum 130.

As shown in FIG. 2B, the facing 170 is defined in a first plane P1 that is perpendicular to a rotational axis 270 for the drum 130. In various embodiments, the first plane P1 may be a leading plane that is furthest on the first end 210a of the drum 130, while in other embodiments, portions of the first rim 220a or the halo 140 may project further outward from the first plane P1. A second plant P2, parallel to the first plane P1, is defined on the second end 210b of the drum 130 by the second rim 220b defines the opening of an attachment cavity in the drum 130 into which an axle seat and other components of a vehicle may be inserted into the wheel 100. Other planes of interest that are parallel to the first plane and the second plane P2 include a third plane P3 that an inward side (e.g., facing the second end 210b of the wheel 100) of a puck 160 is oriented to, a fourth plane P4 that an outward side (e.g., facing the first end 210a of the wheel 100) of the puck 160 is orient to, and a fifth plane P5 to which the interstitial band 240 projects inward towards from the first plane P1.

As used herein, unless another reference point is given or the meaning is clear from supplied context, the terms “central,” “centrally,” and similar terms shall be understood to refer to a relative position of an element as being closer to the axis 270 when measured in a perpendicular plane to the axis 270. In contrast, the terms “radial,” “radially,” and similar terms shall be understood to refer to a relative position of an element as being further from the axis 270 when measured in a perpendicular plane to the axis 270. For example, edge of the interstitial band 240 defined at the first diameter D1 may be considered more radial than the edge of the interstitial band 240 defined at the third diameter D3. In another example, the opening to the well 260 in the first plane P1 is located centrally to the facing 170, and the facing 170 (in turn) is located radially relative to the opening of the well 260.

As used herein, unless another reference point is given or the meaning is clear from supplied context, the terms “inward,” “inwardly”, and similar terms shall be understood to refer to a relative position of an element as being closer to a sixth plane P6, parallel to and located equidistantly to the first plane P1 and the second plane P2. In contrast, the terms “outward,” “outwardly,” and similar terms shall be understood to refer to a relative position of an element as being further from a sixth plane P6-regardless of whether closer to the first plane P1 or the second plane P2. For example, the negative space of the well 260 and the interstitial band 240 project inward from the first plane P1 towards the second plane P2, and as shown the well 260 projects further inward than the interstitial band 240 as the fourth plane P4 is closer to the sixth plane P6 than the fifth plane P5 is. In another example, the circumference of the well 260 may be understood as decreasing as the well 260 projects further inward (e.g., tapering) or as increasing as the well 260 expands outward from the base to the opening in the first plane P1.

The well 260 of the drum tapers from the fourth diameter D4 to a base of a fifth diameter D5, and captures the puck 160 at the base of the well 260 between one or more layers of material used to define the facing 170 and one or more layers of material on which the facing 170 is attached to the first end 210a of the wheel 100 to the sidewall 230 of the drum 130. In various embodiments, the puck 160 is covered by the cap 150 (not shown in FIG. 2A or 2B), which may occupy some or all of the negative space of the well 260, or may project outward from the well 260 and provide various aesthetic designs, provide color options, or provide greater resistance against debris strikes than the inner walls of the well 260. In various embodiments, the well 260 (or the well 260 and the puck 160) includes a cap seat 250 that securing tabs of the cap 150 fit into to secure the cap 150 in the well 260.

When assembled, an interstitial band 240 between the first diameter D1 and the third diameter D3 is sized to accept the insertion of a halo 140 between the first rim 220a and the facing 170. In various embodiments, the dimensions of the third diameter D3 may be different between different wheel drums 130 (while maintaining the same first diameter D1) to affect the width of the interstitial band 240; thereby allowing for larger or smaller halos 140 to be inserted in different wheels 100 using drums 130 sized for the same tires (e.g., by changing the relative ratios of surface areas of the facing 170 and the interstitial band 240).

In various embodiments, the number, size, shape, and relative locations of through holes in the halos 140, and the materials selected for the halos 140 are designed for various purposes or vehicle models so that a user or manufacturer can easily select the appropriate halo 140 for a vehicle. As will be appreciated, the halos 140 may also incorporate different aesthetic designs in addition to the patterns created by the though holes, which a user can freely choose between.

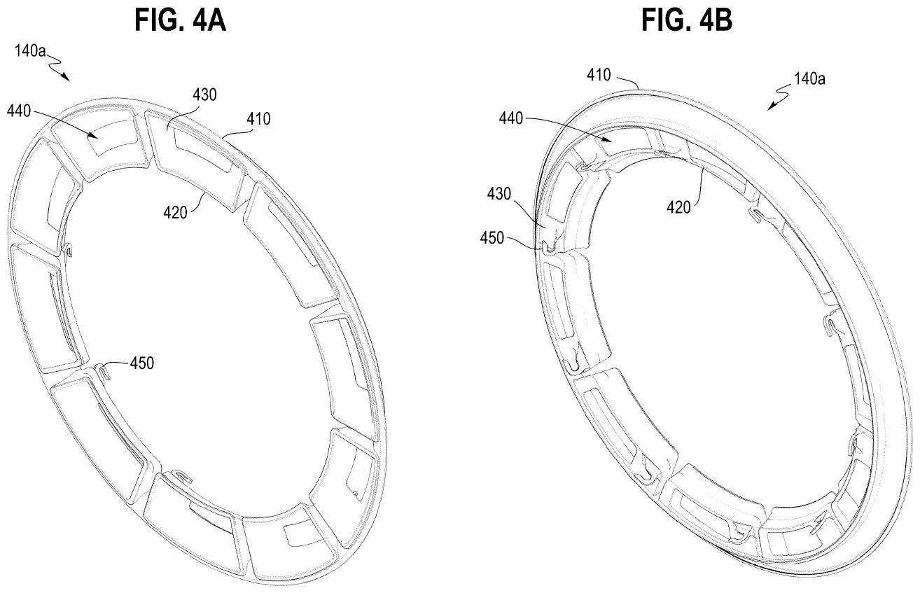

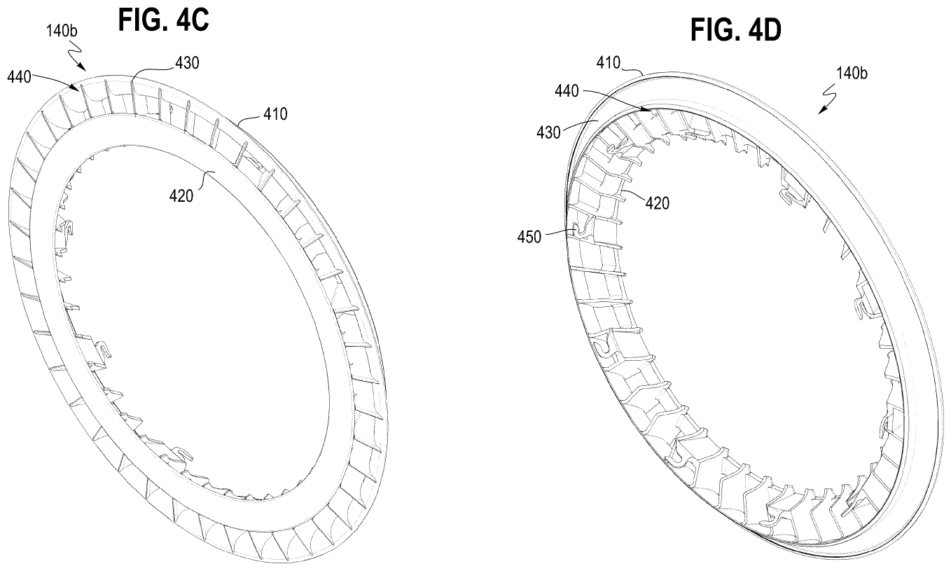

Accordingly, to meet the various mechanical and aesthetic goals of a user or manufacturer, and to improve reparability in the event that the halo 140 is damaged, the halo 140 is secured in the interstitial band 240, but is selectively replaceable. In various embodiments, the halo 140 may be secured to the drum 130 via pressure mounts (e.g., being squeezed inwardly, centrally, or radially, and combinations thereof to the drum 130 until a releasing force is applied), paired magnets in the drum 130 and the halo 140, the use of rotationally secured clasps (as shown in FIGS. 4B and 4D), or various screws/bolts that attach the halo 140 to the drum 130.

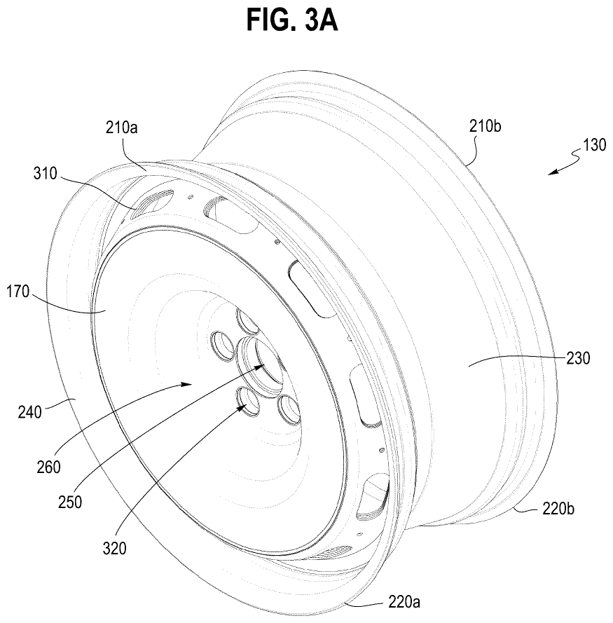

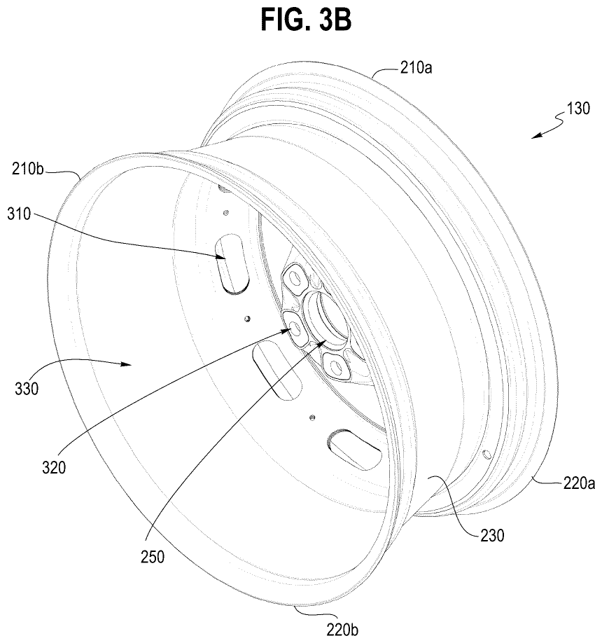

FIGS. 3A-3B illustrate isometric views of example wheel drums 130, according to embodiments of the present disclosure. FIG. 3A shows the example wheel drum 130 from a first angle, showing the portions of the drum 130 that face outward from a vehicle when installed thereto, and FIG. 3B shows the example wheel drum 130 from a second angle, showing the portions of the drum 130 that face inward and towards a vehicle when installed thereto.

The drum 130 includes rims on the first end 210a and the second end 210b that extend from a sidewall 230 used to secure a tire to the drum 130. Internal to the rims, as shown in FIG. 3B, the drum includes a facing 170, and defines an interstitial band 240 between the radial rim 220 and the facing 170 that is sized to fit various halos 140 to the drum 130. As shown in FIG. 3B, the drum 130 defines a drum cavity 330 that the axle and other mounting hardware of the vehicle to which the wheel 100 is attached are disposed when connected to the wheel 100. For example, the rotor, caliper assembly, brake pads/shoes, portions of the axle, various sensors, and the like, can be positioned within the drum cavity 330.

As shown in FIGS. 3A and 3B, one or more vents 310 are arranged circumferentially around the central side of the interstitial band 240 relative to the axis 270 of rotation for the wheel 100 and pass through to the drum cavity 330, which allows air to pass between the first end 210a and the second end 210b of the drum 130 (e.g., to cool brakes held in the drum cavity 330). In various embodiments, the vents 310 include mounting points for the halo 140 to clamp or clip onto the drum 130. The present disclosure contemplates that more or fewer vents 310 of different sizes, shapes, or arrangements may be formed in the drum 130 than are shown in the non-limiting example of FIGS. 3A and 3B.

As shown in FIGS. 3A and 3B, one or more lug holes 320 are defined within the well 260 that pass through to the drum cavity 330, which allow the lugs of the axle seat for the vehicle to pass through the drum 130, which various lug nuts or the like can be used with to secure the axle to the drum 130. The present disclosure contemplates that more or fewer lug holes 320 arranged in different patterns formed in the drum 130 than are shown in the non-limiting example of FIGS. 3A and 3B. In various embodiments, one or more anti-rotation projections from the cap 150 may be secured in corresponding lug holes 320 in addition to or alternatively to securing tabs of the cap 150 that project into and are secured against the cap seat 250 defined concentrically within the well 260.

FIGS. 4A-4D illustrate example halos 140a-b in various views, according to embodiments of the present disclosure. FIGS. 4A and 4B illustrate views of a first halo 140a, while FIGS. 4C and 4D illustrate views of a second halo 140b, having a different design than the first halo 140a. The views shown in FIGS. 4A and 4C show the respective halos 140 from a first angle, showing the portions of the halo 140 that face outward from a vehicle when installed thereto, while views shown in FIGS. 4B and 4D show the respective halos 140 from a second angle, showing the portions of the halo 140 that face inward and towards a vehicle when installed thereto.

Each halo 140 has a radial diameter 410 and a central diameter 420 between which an intake face 430 is defined. In various embodiments, the radial diameter 410 may be equal to, less than, or greater than the first diameter D1 of the drum 130 to control an amount of overlap of the halo 140 relative to the first rim 220a of the drum 130. Similarly, in various embodiments, the central diameter 420 may be equal to, less than, or greater than the third diameter D3 of the drum 130 to control an amount of overlap of the halo 140 relative to the facing 170 of the drum 130.

A plurality of ducts 440 are formed through the intake face 430. As shown in FIGS. 4A-4B versus FIGS. 4C-4D, two halos 140a-b of otherwise similar design may include respective pluralities of ducts 440 that differ in design based on one or more of a size, shape, number, orientation, and relative positioning of the ducts 440. Each of the illustrated pluralities of ducts 440 are arranged circumferentially around the intake face 430 relative to the axis of rotation for the wheel 100. In various embodiments, the number and placement of the ducts 440 is based on the number and placement of the vents 310 into the cavity 330 of the drum 130 and the cooling needs of components held within the cavity 330. Accordingly, the different halos 140 may be used with the same drums 130, to thereby provide different air through-put characteristics, damage protection characteristics, weight profiles, or aesthetics.

On a back side of each halo 140, as shown in FIGS. 4B and 4D, various engagement devices 450 may be provided to secure the halos 140 within the interstitial band 240 of the drum 130. As illustrated, the engagement devices 450 include clips that are configured to engage with the vents of the drum when the halo 140 is rotated in a first direction while inserted in the interstitial band 240, and disengage from the vents of the drum 130 when rotated in a second direction by a user (e.g., clockwise vs. counterclockwise) to allow a user to remove the halo 140 from the interstitial band 240. Although shown with clips that rotate to secure the halo 140 with the drum 130, in various embodiments, other engagement devices 450 may be used such as pressure mount clips, tabs, magnets (with corresponding magnets or ferromagnetic blocks within the wall of the drum 130), screws/bolts, threads on an edge of the halo 140 to engage with threads in the interstitial band 240, etc.

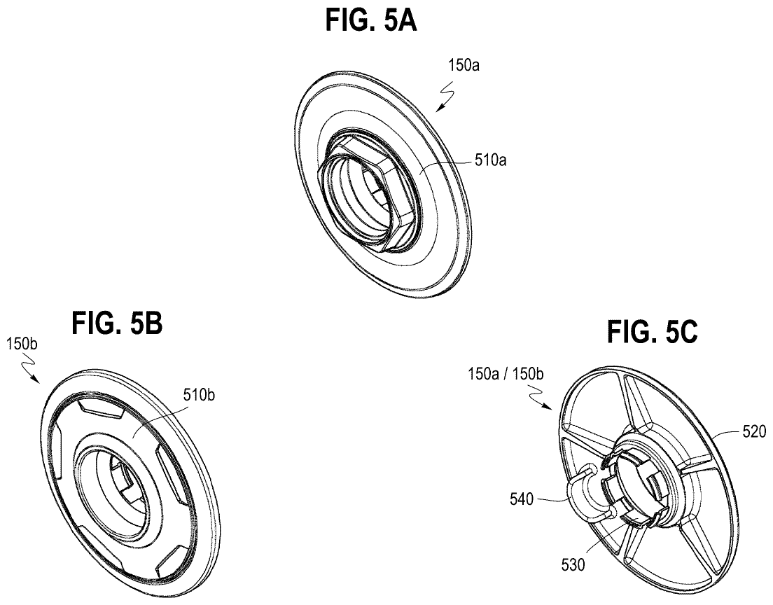

FIGS. 5A-5C illustrates isometric views of example caps 150a-b, according to embodiments of the present disclosure. FIG. 5A illustrates a view of a first cap 150a and FIG. 5B illustrates a view of a second cap 150b showing the portions of the respective caps 150 that face outward from a vehicle when installed thereto. FIG. 5C illustrates a view of a cap 150 (e.g., the first cap 150a, the second cap 150b, or another design of cap 150) showing the portions of the caps 150 that face inward and towards a vehicle when installed thereto.

The outward faces 510 of the caps 150 may include various aesthetic designs from one another, may be of different heights or dimensions (e.g., to project outward from the well 260 to different extents, to provide a flat face 510 coplanar with the facing 170) while still using identical back faces 520. Accordingly, a user can swap the cap 150 in a wheel 100 for a new cap 150 without disconnecting other components of the wheel 100. The front face 510 covers any lugs protruding from the axle seat of a vehicle that the wheel 100 is connected to, provide aerodynamic improvements to the wheel 100, and improves the aesthetic appeal of the wheel 100.

The back face 520 includes various hardware to connect the cap 150 to the drum 130 and prevent or reduce rotation of the cap 150 relative to the drum 130. For example, a plurality of securing tabs 530 may project from the cap 150 and match to one or more corresponding slots for a cap seat 250 so that a user may push the cap 150 inward to the wheel 100 to snap the cap 150 in place. In an additional example, some embodiments of the cap 150 include one or more anti-rotation projections 540 that are configured to be inserted into the lug holes 320 of the drum 130 or other slots that are defined off-center to the axis 270 of rotation for the wheel 100 to thereby prevent rotation or reduce the freedom of rotation of the cap 150 relative to the rest of the wheel 100 when installed therein.

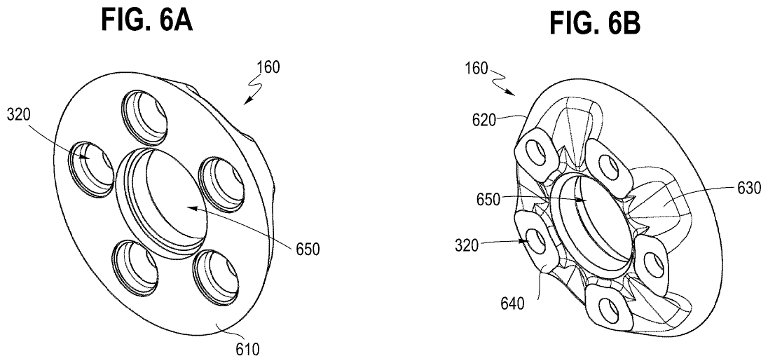

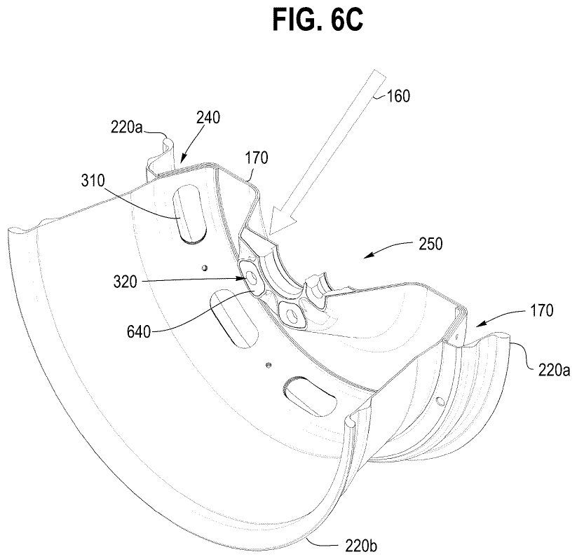

FIGS. 6A-6C illustrate views of an example puck 160, according to embodiments of the present disclosure. FIG. 6A illustrates a view of a puck 160 showing the portions of the puck 160 that face outward from a vehicle when installed thereto. FIG. 6B illustrates a view of a puck 160 showing the portions of the puck 160 that face inward and towards a vehicle when installed thereto. FIG. 6C illustrates how the puck 160 is captured by the wheel drum 130.

Although in various embodiments the drum 130 is made of a fiber reinforced thermoplastic or resin material, the puck 160 may instead be made of a metal, such as aluminum, steel, cast iron, bronze, or the like, and is captured in place at the base of the well 260 by one or more layers of the drum material on an inward side of the puck 160 and by one or more layers of the drum material on an outward side of the puck 160. Accordingly, the axle connection formed at the base of the well 260 with the puck 160 provides a metal-to-metal connection between the wheel 100 and an axle seat of the vehicle.

The puck 160 includes a plurality of lug holes 320 that run from a first face 610 to a second face 620. The first face 610 is generally flat, and when installed at the base of the well 260, faces toward the first end 210a of the wheel 100. In contrast, when the puck 160 is installed at the base of the well 260, the second face 620 faces toward the second end 210b of the wheel 100. Additionally, the second face 620 includes various indentations 630 that serve to ensure that the rotational energy imparted by a rotating axel connected to the puck 160 is transferred to the drum 130 with reduced or no slippage between the drum 130 and the puck 160.

The puck 160 serves as a connection point for the axle seat of a vehicle's axle to connect to the wheel 100, which is likely made of a metal, as are the lugs of the axle. In some embodiments, by making the puck 160 of a different material than the drum 130 (e.g., a denser thermoplastic, a composite with a different ratio of resin to reinforcement material), the puck 160 provides a more impact-resistant and crush-resistant surface to join the axle to the wheel 100 than the material used by the drum 130. By making the puck 160 of a metal, and exposing portions of the puck 160 from the material of the drum 130, the puck 160 provides for metal-on-metal contact between the axle and the wheel 100, rather than metal-on-plastic contact, which may damage the plastic, particularly if the lug nuts used to secure the lugs are overtightened over a plastic material or when the plastic is subject to damage during a rough installation of the drum 130 to the axle.

Accordingly, in some embodiments the lug holes 320 are tapered to have a larger diameter on the first face 610 than on the second face 620, to thereby allow the lugs to pass through the smaller opening on the second face 620, and for the lug nuts that fasten around the lugs to seat in the larger opening on the first face 610. Thereby, the lug nuts may avoid fastening over the material of the drum 130, and be tightened down into the material of the puck 160. Additionally, the lug holes 320 are defined in exposed surfaces 640 of the puck 160 so that when the lugs of the axle seat are secured to the lugs places through the lug holes 320, the material of the exposed surfaces 640 contacts the axle seat, while the material of the drum 130 avoids contact or does not contact with axle seat.

A central hole 650 may be defined centrally in the puck 160, which is concentrically aligned with the axis 270 of rotation for the drum 130 when the puck 160 is installed therein. The central hole 650 may be formed to reduce the weight of the puck 160, but also serves as a potential connection point for a cap 150, which can be used to cover or otherwise hide from view any of the lugs or lug nuts used to secure the wheel 100 to a vehicle.

Although illustrated with five lug holes 320, the present disclosure contemplates that a puck 160 may be configured with more or fewer lug holes 320 than illustrated in the examples, and that the pattern of the lug holes 320 may also vary from what is illustrated, based on the number and placement of the lugs of a vehicle axle to which the wheel 100 is to be installed.

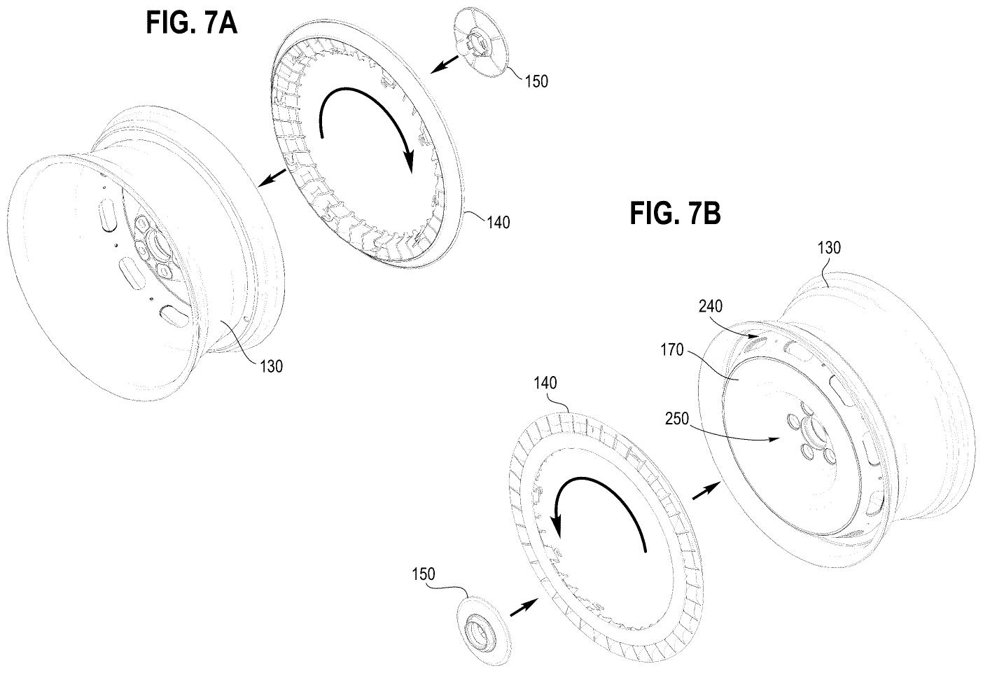

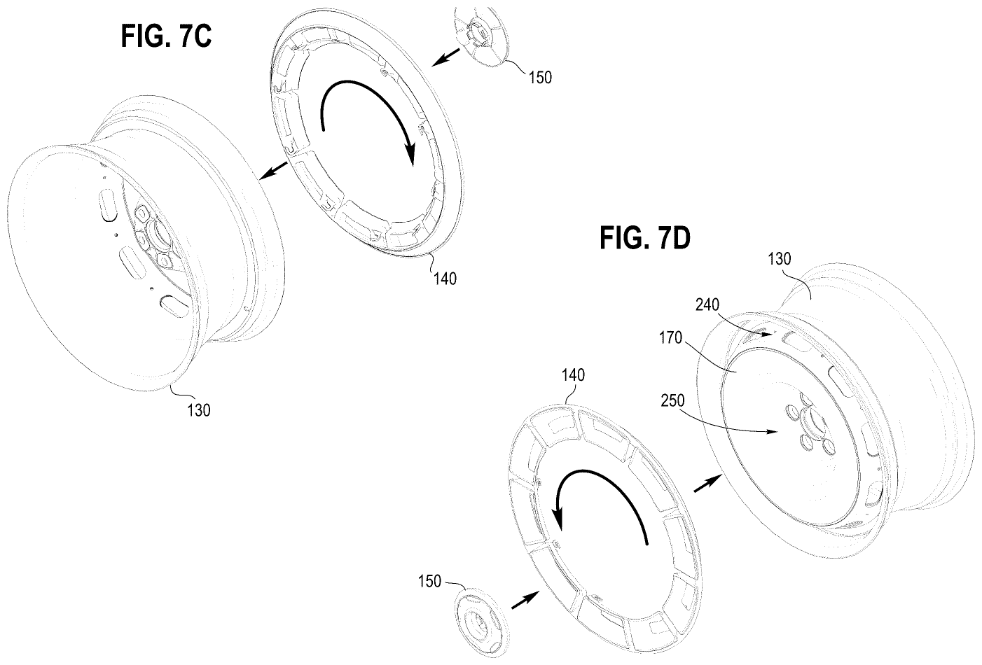

FIGS. 7A-7D illustrate exploded views of a wheel 100, according to embodiments of the present disclosure. FIGS. 7A and 7B illustrate views of a first assembly 710a, while FIGS. 7C and 7D illustrate views of a second assembly 710b, having a different design than the first assembly 710a. The views shown in FIGS. 7A and 7C show the assemblies 710a-b from a first angle, showing the portions of the wheel 100 that face outward from a vehicle when installed thereto, while views shown in FIGS. 7B and 7D show the respective assemblies 710a-b from a second angle, showing the portions of the wheel 100 that face inward and towards a vehicle when installed thereto.

When assembling a wheel 100, the halo 140 is inserted into the interstitial band 240 and then secured to the drum 130 (e.g., by snapping into place via pressure mounts, via rotating engagement devices 450 to engage with corresponding features on the drum 130, etc.). When disassembling the wheel 100, to repair or replace (e.g., for aesthetic or performance purposes) a halo 140, the halo 140 is released from the interstitial band 240 (e.g., by disengaging pressure mounts from constricting joints, via rotating in an opposite direction than used for assembly, etc.) and removed from the interstitial band 240.

When assembling a wheel 100, the cap 150 is inserted into the well 260 and then secured to the drum 130 (e.g., by snapping into place via pressure mounts, via rotating engagement devices 450 to engage with corresponding features on the drum 130, etc.). When disassembling the wheel 100, to repair or replace (e.g., for aesthetic or performance purposes) a cap 150, the cap 150 is released from the cap seat 250 (e.g., by rotating in an opposite direction than used for assembly) and removed from the well 260.

A user may repeat the assembly and disassembly process leaving other components of the wheel 100 in place. For example, a tire 120 connected to the drum 130 may remain connected to the drum 130 while installing or uninstalling a halo 140 or cap 150. Similarly, a cap 150 may remain installed while installing or uninstalling a halo 140, and a halo 140 may remain installed while installing or uninstalling a cap 150. Additionally, after being initially installed and uninstalled, a user may reuse a halo 140 or a cap 150; choosing to install those halos 140 or caps 150 to the same or a different wheel drum 130 at a later time.

FIG. 8 illustrates a protective use case of an example wheel 100, according to embodiments of the present disclosure. The tire 120, the halo 140, and the facing 170 (and in some embodiments, the cap 150) obscure and protect the wheel drum 130 from debris 820 and prevent other objects from making direct contact with the structure of the wheel drum 130, thereby providing a protective layer for the thermoplastic material of the wheel drum 130. In various embodiments, the halo 140 or the cap 150 are made of a different material than the wheel drum 130 to provide a more durable exterior surface for the wheel 100 or an easier-to-replace component to restore functionality and appearance to the wheel 100 when being repaired. These different materials can including different mixtures of resin/fiber for a carbon-fiber reinforced thermoplastic that offer different mechanical properties than the thermoplastic used in the wheel drum 130 as well as thermoset plastics, metal alloys, or the like.

In various embodiments, the halo 140 extends to cover the outward surfaces of the first rim 220a so that the first rim 220a is protected from curb strikes or debris strikes; allowing for the smaller, less expensive, and potentially more damage-resilient halo 140 to make contact with a curb 810 or debris 820 instead of the drum 130. Because the halo 140 extends over the rim 220a (at or beyond the first diameter D1) of the drum 130 and extends to the third diameter D3, any impact between the first diameter D1 and the third diameter D3 is absorbed by the halo 140; preventing damage to the underlying portions of the larger and more difficult to replace drum 130. Accordingly, by using the design described herein, after a driver strikes a curb 810, the halo 140 is damaged but the drum 130 remains undamaged. After such a curb strike or other damage is sustained, the damaged halo 140 may be removed from the wheel 100 and be replaced with another instance of the halo 140, without having to replace other components of the wheel 100, thereby easing repair and replacement as an additional benefit of the present design.

Similarly, by using the design described herein, after debris 820 strikes and damages the halo 140, the damaged halo 140 may be removed from the wheel 100 and replaced with another instance of the halo 140, without having to replace other components of the wheel 100.

Because the facing 170 is generally “flat” and is substantially perpendicular to an axis 270 of rotation for the wheel 100 (and therefore parallel to a direction of travel for the wheel 100), any debris 820 that strikes the facing 170 is likely to do so at an oblique angle of impact; thereby avoiding full transfer of impact force to the wheel 100 and reducing the likelihood of the debris 820 causing damage to the facing 170. In some embodiments, the facing 170 may include additional layers of material or coatings that are not present elsewhere on the drum 130, to provide greater protection on the external portions of the wheel 100 without adding weight to portions of the wheel that do not need such protection.

Although the well 260 provides surfaces that are angled towards the direction of travel for the wheel 100 that debris 820 may strike (e.g., not parallel to the direction of travel), the area of the well 260 is smaller than the wheel 100 as a whole (reducing the odds of a strike) and are presented at a sloped angle to the direction of travel; thereby increasing the effective thickness of the material and thereby reducing the likelihood of a direct impact for debris 820. The sloped walls of the well 260 provided by the present design increase the odds of any debris 820 that does strike the well 260 to glance off with lower transfer of force than a direct impact, thereby improving the resiliency of the wheel 100 against damage. In some embodiments, the cap 150 extends to be flush with the facing 170; thereby protecting any such surfaces of the well 260 from debris strikes by not exposing those surfaces.

FIGS. 9A-9B illustrate differences in airflows in different example wheel designs, according to embodiments of the present disclosure. As shown in FIG. 9A, a first configuration of a wheel 100 with a first halo 140a and first facing 170a produces a first airflow pattern 910a (generally or collectively, airflow pattern 910), while a second configuration of a wheel, as shown in FIG. 9B, produces a second airflow pattern 910b via a second halo 140b and second facing 170b.

As shown, different amounts of air, at different locations on the wheels 100 in each of the airflow patterns 910 are drawn into the wheel assembly as intake air 920, directed to flow past the wheel assembly as pass-by air 930, or ejected from the wheel assembly as outflow air 940.

Because the facing 170 is generally perpendicular to the direction of travel and does not include any through holes into the cavity 330, the surrounding air is drawn into the wheel assembly via the ducts 440 in the halo 140 forward on the vehicle in the direction of travel and routed into the cavity 330 via the vents 310. The air drawn into the cavity 300 is then ejected from the cavity 300, having absorbed heat from the components in the cavity 330, in the reverse route-exiting the vents 310 and then the ducts 440 in the halo 140 rearward on the vehicle in the direction of travel. The intake air 920 may be draw into the forward ducts 400 via air intake scoops or other structures on the halo 140, and ejected from the cavity 300 via a pressure differential (e.g., being forced out may new incoming intake air 920 or drawn out via a suction effect from the lower pressure pass-by air 930 at rearward ducts 400, etc.

By excluding through holes, the facing 170 provides fewer inlets or outlets for air, and thereby decreases the aerodynamic drag on the wheel 100 associated with the intake and outtake of air to/from the cavity 330 and turbulent effects at the intake and outtake points. As up to 30% of the aerodynamic drag of a modern vehicle can be attributed to the wheels, regulating the amount of air that is permitted to flow into the wheel assembly can noticeably improve the aerodynamic performance of the vehicle as a whole; thereby improving fuel economy or battery range, particularly when operated at higher speeds as air drag increases. However, as the wheels include components that may require cooling (e.g., brake pads, electric motors, electrical generators, wheel bearings, etc.), the improvements to aerodynamic performance may need to be balanced for competing needs for aerodynamic efficiency and cooling ability. For example, decreasing the amount of air drawn into the wheel assembly can increase aerodynamic performance, but also decreases the amount of air available for cooling (e.g., of brakes held in the cavity 330 of the wheel 100), while increasing the amount of air drawn into the wheel assembly can decrease aerodynamic performance, but increases the amount of air available for cooling.

By installing selectively configurable wheels 100, as discussed in the present disclosure, a user can select a halo 140 with different numbers, sizes, shapes, or arrangements of ducts 440, thereby affecting how much air is drawn into the cavity 330 of the wheel 100, which may be used to cool any components (e.g., breaks) held therein, versus being directed to pass by the wheel 100. These considerations may be based on the operational profile of the vehicle to adjust for the speed of travel, cooling needs of internal components, and susceptibility to damage of the wheel 100 in the operational environment.

For example, a user of a vehicle that is primarily driven on a highway, may prefer a halo 140 design that helps reduce aerodynamic drag at higher speeds at the expense of less intake of cooling air, as the brakes are used less frequently on controlled access highways than in other environments, which thereby improves fuel/battery efficiency by reducing airflow through the wheel 100. In contrast, that same user of the same vehicle may prefer a different design of halo 140 that offers a different airflow pattern 910 when using the vehicle off-road (e.g., emphasizing debris protection over weight and drag reduction) or driving within a city (e.g., emphasizing air through-put to the brake pads due to more frequent use in city vs. highway driving over weight and drag reduction). Additionally, that same user of the same vehicle may prefer a different design for the halo 140 when operating the vehicle in the winter versus the summer while primarily operating on controlled access highways, due to the air used to cool components being colder and the presence of more debris (in the form of road salt, gravel, or cinders); changing the user's relative needs for cooling and protection without affecting the driving patterns for the vehicle.

The configurable wheel 100 of the present disclosure therefore provides several advantages to the user, allowing for the customization of the wheel 100 to account for differing priorities for aerodynamics, protection, and cooling capabilities via selectively removable sub-components of the wheel assembly.

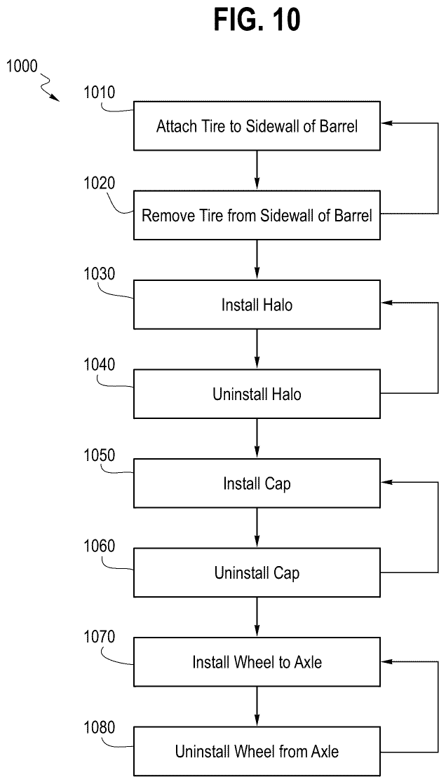

FIG. 10 is a flowchart of an example method 1000 for wheel configuration or repair, according to embodiments of the present disclosure.

Method 1000 begins at block 1010, where an operator attaches a tire to a sidewall 230 of the drum 130. The operator uses the mating surfaces of the first rim 220a and the second rim 220b, disposed on opposing sides of the wheel drum 130 from one another, to secure the beads of the tire 120 to the rims 220 to secure the tire 120. The operator may then inflate the tire 120 (or an inner tube held between the tire 120 and the drum 130). In various embodiments, the tire 120 remains attached to the sidewall 230 when installing and uninstalling a halo 140 or a cap 150 with the drum 130, or the wheel 100 with a vehicle (e.g., any of the operations discussed in blocks 1030-1080).

At block 1020, the operator removes the tire from the sidewall 230 of the drum 130, for example, when replacing a tire 120 with a worn tread or that has been damaged, when swapping between winter and all-weather tires 120, or the like. In various embodiments, any installed halos 140 or caps 150 may remain installed with the drum 130, while uninstalling a tire 120 per block 1020. In some embodiments, the drum 130 may also remain installed to the vehicle while removing the tire 120, although the operator may prefer to uninstall the wheel 100 from the vehicle to provide greater access to the second rim 220b than is afforded by a wheel well of the vehicle.

After performing block 1020, method 1000 may return to block 1010 for the operator to install a new (or newly repaired) tire 120 to the drum 130, but various other operations of method 1000 may be performed between the completion of block 1020 and performance of block 1010.

At block 1030, the operator installs the halo 140. In various embodiments, the operator inserts a halo 140 in an interstitial band 240 of the drum 130 located between a first rim 220a and a facing 170 of the drum 130. Once inserted, the operator then secures the halo 140 to the wheel drum 130 via various devices 450 and corresponding features in the drum 130. In various embodiments, the halo 140 remains installed as the operator installs or uninstalls tires 120 or caps 150, or the wheel with a vehicle (e.g., any of the operations discussed in blocks 1010-1020 and 1050-1080).

At block 1040, the operator uninstalls the halo 140, for example, when replacing a halo 140 that has been damaged or to change a first halo 140a for a second halo 140b with a different design. For example, a first halo 140a that includes a first plurality of ducts 440 may be removed to allow for the installation of a second halo 140b that includes a second plurality of ducts 440 that is different based on a different design. The different design may include one or more of: a different number of ducts 440 in the first plurality versus the second plurality; a different cross-sectional area of each duct 440 in the first plurality versus the second plurality; a different orientation of each duct 440 through a respective halo 140 in the first plurality versus the second plurality; and a different cross-sectional shape of each duct 440 in the first plurality versus the second plurality, and combinations thereof. In various embodiments, any installed tires 120 or caps 150 may remain installed with the drum 130, and the drum 130 may also remain installed to the vehicle while uninstalling a halo 140 per block 1040.

After performing block 1040, method 1000 may return to block 1030 for the operator to install a new (or newly repaired) halo 140 to the drum 130, but various other operations of method 1000 may be performed between the completion of block 1040 and performance of block 1030.

At block 1050, the operator installs the cap 150. In various embodiments, the operator inserts a cap 150 in a well 260 of the drum 130 located centrally to the facing 170 of the drum 130. Once inserted, the operator then secures the cap 150 to the wheel drum 130 via various securing tabs 530 and the cap seat 250 in the drum 130. In various embodiments, the cap 150 mates with various lug holes 320 in a puck 160 captured in the base of the well 260, such as by inserting an anti-rotation projection 540 into a lug hole 320 or the securing tabs 530 through a central hole 650. In various embodiments, the cap 150 remains installed as the operator installs or uninstalls tires 120 or halos 140, or the wheel 100 with a vehicle (e.g., any of the operations discussed in blocks 1010-1040 and 1070-1080).

At block 1060, the operator uninstalls the cap 150, for example, when replacing a cap 150 that has been damaged or to change a first cap 150a for a second cap 150b with a different design. For example, a first cap 150a that projects a face outward to be even with the facing 170 may be removed to allow for the installation of a second cap 150b that includes that includes a through-hole to the axle seat. In various embodiments, any installed tires 120 or halos 140 may remain installed with the drum 130, and the drum 130 may also remain installed to the vehicle while uninstalling a cap 150 per block 1060.

After performing block 1060, method 1000 may return to block 1050 for the operator to install a new (or newly repaired) cap 150 to the drum 130, but various other operations of method 1000 may be performed between the completion of block 1060 and performance of block 1050.

At block 1070, the operator installs the wheel 100 to the axle of a vehicle. In various embodiments, the facing 170 defines a well 260 projecting inward to the wheel drum 130 includes a puck 160 at a base of the well 260 (defined in the facing 170) that includes a plurality of lug holes 320, and the operator inserts a corresponding plurality of lugs of an axle attachment seat of a vehicle through those lug holes 320. Once the lugs are inserted, the operator secures the lugs to the lug holes 320, such as via lug nuts, to affix the wheel drum 130 to the axle of the vehicle. In various embodiments, the wheel 100 remains installed as the operator installs or uninstalls tires 120, halos 140, or the cap 150 with a drum 130 (e.g., any of the operations discussed in blocks 1010-1060).

At block 1080, the operator uninstalls the wheel 100 from the axle, for example, when replacing a damaged wheel, rotating the wheel among different positions on the vehicle, accessing components held in the cavity 330 of the drum 130, or the like. In various embodiments, any installed tires 120, halos 140, or caps 150 may remain installed with the wheel 100 removed from the vehicle per block 1080.

After performing block 1080, method 1000 may return to block 1070 for the operator to install the drum 130 or a new drum 130 back onto the vehicle, but various other operations of method 1000 may be performed between the completion of block 1080 and performance of block 1070.

Although FIG. 10 present the flowchart of the example method 1000 is a set order, the present disclosure contemplates that the various operations may be performed in any order, and that various operations may be omitted based on the operational conditions. For example, an operator may perform the operations of block 1060 before performing any of the operations discussed in the other blocks, or may omit performing block 1030 and block 1050 (to remove halos 140 or cap 150) during an initial installation operation, but perform blocks 1030 and block 1050 before performing block 1020 or block 1040, respectively, in a subsequent installation operation. Accordingly, one of ordinary skill in the relevant art will understand which of the operations are to be performed, and the order in which those operations are to be performed, according to the operational conditions in which method 1000 is performed.

The descriptions and illustrations of one or more embodiments provided in this disclosure are intended to provide a thorough and complete teaching of the full scope of the subject matter to those of ordinary skill in the relevant art and are not intended to limit or restrict the scope of the subject matter as claimed in any way. The embodiments, examples, and details provided in this disclosure are considered sufficient to convey possession and enable those of ordinary skill in the relevant art to practice the best mode of the claimed subject matter. Descriptions of structures, resources, operations, and acts considered well-known to those of ordinary skill in the relevant art may be brief or omitted to avoid obscuring lesser known or unique aspects of the subject matter of this disclosure. The claimed subject matter should not be construed as being limited to any embodiment, aspect, example, or detail provided in this disclosure unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently.

Having been provided with the description and illustration of the present disclosure, one of ordinary skill in the relevant art may envision variations, modifications, and alternative embodiments falling within the spirit of the broader aspects of the general inventive concept provided in this disclosure that do not depart from the broader scope of the present disclosure.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof.

As used in the present disclosure, the terms “substantially”, “approximately”, “about”, and other relative terms encompass values within +5% of a stated quantity, percentage, or range unless a different approximation is explicitly recited in relation to the stated quantity, percentage, or range or if the context of the value indicates that a different approximation would be more appropriate. For example, a value identified as about X % may be understood to include values between 0.95*X % and 1.05*X % or between X−0.05X and X+0.05X percent, but may stop at zero or one hundred percent in various contexts. In another example, a feature described as being substantially parallel or perpendicular to another feature shall be understood to be within ±9 degrees of parallel or perpendicular. Any value stated in relative terms shall be understood to include the stated value and any range or subrange between the indicated or implicit extremes.

As used in the present disclosure, all numbers given in the examples (whether indicated as approximate or otherwise) inherently include values within the range of precision and rounding error for that number. For example, the number 4.5 shall be understood to include values from 4.45 to 4.54, while the number 4.50 shall be understood to include values from 4.495 to 4.504. Additionally, any number or range that explicitly or by context refers to an integer amount (e.g., approximately X users, between about Y and Z states), shall be understood to round downward or upward to the next integer value (e.g., X+1 users, γ—1 and Z+1 states).

The following claims are not intended to be limited to the embodiments shown herein, but are to be accorded the full scope consistent with the language of the claims. Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112 (f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

We claim:

1. A wheel, comprising:
a wheel drum, the wheel drum having a first rim of a first diameter on a first end of the wheel drum;
a second rim of the first diameter on a second end, opposite to the first end, of the wheel drum;
a facing that extends between a second diameter and a third diameter positioned concentrically to the first rim on the first end in a plane substantially perpendicular to an axis of rotation of the wheel drum; and
a cavity defined inward from the second rim from the second end toward the first end; and
a halo, connected to the wheel drum in an interstitial band defined on the first end between the first diameter and the second diameter.

2. The wheel of claim 1, wherein the facing occupies between 25 and 40 percent of an area defined by a circle of the first diameter.

3. The wheel of claim 1, further comprising:
an axle connection defined within a well concentrically defined in the facing, the well extending towards the second end.

4. The wheel of claim 3, further comprising:
a puck secured at a base of the well in which the axle connection is defined.

5. The wheel of claim 3, further comprising:
a cap secured in the well over the axle connection.

6. The wheel of claim 5, wherein the cap defines a coplanar surface to the facing.

7. The wheel of claim 1, wherein the halo is made of a reinforced thermoplastic.

8. The wheel of claim 1, wherein the wheel drum is made of a reinforced thermoplastic.

9. The wheel of claim 1, wherein the halo includes a plurality of ducts arranged circumferentially around the axis of rotation and the interstitial band includes a plurality of vents arranged circumferentially around the axis of rotation.

10. The wheel of claim 9, wherein the halo is configured to selectively engage with the wheel drum, further comprising:
a second halo, configured to selectively engage with the wheel by connecting in the interstitial band, wherein the second halo includes a second plurality of ducts different from the plurality of ducts.

11. The wheel of claim 1, wherein the halo has a fourth diameter greater than the first diameter.

12. The wheel of claim 1, further comprising a tire, secured to the wheel drum between the first rim and the second rim.

13. A system, comprising:
a wheel drum, having:
a first rim of a first diameter on a first end;
a second rim of the first diameter on a second end opposite to the first end; and
a sidewall connected to the first rim and the second rim, having a second diameter less than the first diameter;
wherein the first end defines:
an interstitial band, extending inward from the first rim toward the second end, the interstitial band positioned circumferentially between the first diameter and a third diameter, less than the first diameter;
a facing, positioned extending substantially perpendicular to an axis of rotation of the wheel drum, the facing positioned circumferentially between the third diameter and a fourth diameter, less than the third diameter; and
a well, extending inward from the facing toward the second end, the well positioned circumferentially within the fourth diameter;
wherein the second end defines:
a cavity, extending inward from the second rim towards the first end;
a first halo, having:
a first engagement device, configured to selectively attach to the first end of the wheel drum within the interstitial band; and
a first intake face, defining a first plurality of ducts defined circumferentially around the first halo;
a second halo, having:
a second engagement device, configured to selectively attach to the first end of the wheel drum; and
a second intake face, defining a second plurality of ducts defined circumferentially around the second halo, wherein the second plurality of ducts differs in design from the first plurality of ducts.

14. The system of claim 13, wherein the first plurality of ducts differs from the second plurality of ducts in design by at least one of:
a number of ducts in the first plurality of ducts versus the second plurality of ducts;
a cross-sectional area of each duct in the first plurality of ducts versus the second plurality of ducts;
an orientation of each duct through a respective halo in the first plurality of ducts versus the second plurality of ducts; and
a cross-sectional shape of each duct in the first plurality of ducts versus the second plurality of ducts.

15. The system of claim 13, further comprising:
a puck defined at a base of the well in which an axle connection is defined.

16. The system of claim 13, further comprising:
a cap connected over the well coplanar with the facing.

17. The system of claim 13, wherein the wheel drum is made of a fiber reinforced thermoplastic.

18. The system of claim 13, wherein the first halo and the second halo are made of a fiber reinforced thermoplastic.

19. The system of claim 13, wherein the facing occupies between 25 and 40 percent of an area defined by a circle of the first diameter.

20. The system of claim 13, wherein the interstitial band occupies between 20 and 40 percent of an area defined by a circle of the first diameter.

21. The system of claim 13, wherein the first halo has a first radial diameter greater than the first diameter and a first central diameter equal to the third diameter and the second halo has a second radial diameter equal to the first diameter and a second central diameter equal to the third diameter.

22. A method, comprising:
inserting a first halo including a first plurality of ducts in an interstitial band of a wheel drum to between a first rim and a facing of the wheel drum, the first rim having a first diameter and the facing occupying a region substantially perpendicular to an axis of rotation of the wheel drum between a second diameter and a third diameter, wherein the second diameter is less than the first diameter and the third diameter is less than the second diameter;
securing the first halo to the wheel drum;
releasing the first halo from the wheel drum;
removing the first halo from the interstitial band;
inserting a second halo in the interstitial band, the second halo including a second plurality of ducts different in design from the first plurality of ducts; and
securing the second halo to the wheel drum.

23. The method of claim 22, further comprising:
attaching a tire to a sidewall of the wheel drum via a mating surface of the first rim and a second rim, disposed on an opposite end of the wheel drum from the first rim, wherein the tire remains attached to the sidewall while releasing the first halo, removing the first halo, inserting the second halo, and securing the second halo.

24. The method of claim 22, wherein the facing defines a well projecting inward to the wheel drum and including a puck at a base of the well including a plurality of lug holes, the method further comprising:
inserting a corresponding plurality of lugs of an axle attachment seat of a vehicle through the lug holes; and
securing the lugs to the lug holes to affix the wheel drum to an axle of a vehicle, wherein the axle remains attached to the wheel drum while releasing the first halo, removing the first halo, inserting the second halo, and securing the second halo.

25. The method of claim 24, further comprising:
attaching a cap in the well over the lugs that project through the puck into the well.
